(19) United States
(12) Patent Application Publication
(10) Pub. No.: US 2026/0084522 A1
(43) Pub. Date: Mar. 26, 2026

(54) Method and Device for Controlling a Safety-Related Function of a Motor Function

(71) Applicant: Bayerische Motoren Werke Aktiengesellschaft, Muenchen (DE)

(72) Inventors: Thorsten KNOTT, Tuntenhausen (DE); Thomas WURSTHORN, Muenchen (DE)

(21) Appl. No.: 19/319,873

(22) Filed: Sep. 5, 2025

(30) Foreign Application Priority Data
Sep. 20, 2024 (DE) 10 2024 127 150.7

(51) Int. Cl. B60K 35/10

(52) U.S. Cl. CPC B60K 35/10; B60K 2360/573

(57) ABSTRACT

A method and a device for controlling a safety-related function of a motor vehicle are provided. The method includes acquisition of an approach of a user terminal device to a motor vehicle, acquisition of a first user input of a user on a user terminal device, execution of a safety-related function of the motor vehicle in response to the first user input, acquisition of a second user input of a user on a user terminal device, and interruption of the execution of the safety-related function of the motor vehicle in response to the second user input.

### CROSS REFERENCE TO RELATED APPLICATION

This application claims priority under 35 U.S.C. § 119 from German Patent Application No. 10 2024 127 150.7, filed Sep. 20, 2024, the entire disclosure of which is herein expressly incorporated by reference.

### BACKGROUND AND SUMMARY

The invention relates to a method and a device for controlling a safety-related function, in particular a hatch of a motor vehicle.

A system for an exchange of data between at least one vehicle and at least one mobile terminal device is known, for example, from published document DE 10 2014 203 060 A1.

The object of the invention is the disclosure of an improved method and an improved device for controlling a safety-related function of a motor vehicle.

According to the invention, this object is fulfilled by the subject matter of the independent patent claims. Advantageous embodiments of the invention are the subject matter of the dependent patent claims and the description.

A method according to the invention for controlling a safety-related function of a motor vehicle thus comprises the following steps: acquisition of an approach of a user terminal device to a motor vehicle, acquisition of a first user input of a user on a user terminal device, execution of a safety-related function of the motor vehicle in response to the first user input, acquisition of a second user input of a user on a user terminal device, and interruption of the execution of the safety-related function of the motor vehicle in response to the second user input.

In particular, the method according to the invention is employed for the initiation of a safety-related function of motor vehicle and, optionally, for the interruption or suspension thereof, in particular prior to a completion of the safety-related function, for example, in the event of an emergency, on the grounds that, for example, a safety-related emergency associated with the execution of the function is impending or has already occurred.

A motor vehicle is customarily designed for the execution of one or more safety-related functions which can be controlled by a user terminal device or a user input, particularly in the event that the user terminal device is located in proximity or within range. In particular, safety-related functions of the motor vehicle of this type, which functions can be controlled by the user terminal device, are movements of moving parts of the motor vehicle such as, for example, the opening and/or closing of a hatch, as further described hereinafter. In particular, the safety-related function is a function of the motor vehicle wherein a person, in particular a person in proximity to the motor vehicle who can be stationary themselves, in particular during the execution of the safety-related function, might sustain injury, for example, on the grounds of crushing or compression resulting from a moving part of the motor vehicle.

A user terminal device which is configured for the actuation or execution of these safety-related functions is a device or an apparatus which is designed for the reception of user inputs and/or user commands, and for communication with a motor vehicle, for the delivery of these user inputs to the motor vehicle.

In particular, the at least one user terminal device is a portable or mobile device which is distinct from the motor vehicle and which, in particular, can be configured as a “smart device”, i.e., as a device having at least one processor, such as, for example a smartphone, a phablet or tablet, a smart watch, smart glasses and/or a wearable device, which device can also assume other functions such as, for example, telephone functions, web browsing or messaging services, for example, by means of apps or programs.

Alternatively or additionally, however, the user terminal device can also be configured as a proprietary device such as a physical key, a fob and/or a wireless remote control which is exclusively configured for the execution of the steps described in conjunction with the method according to the invention, or at least for the initiation of the support thereof.

In particular, the user terminal device is designed for the execution of one or more functions, in particular safety-related functions with respect to one or more motor vehicles such as, for example, a locking and/or unlocking of one or more hatches and also the active opening and/or closing of one or more hatches.

Functions or interactions with the motor vehicle of this type, in particular such functions as enable an access function or a hatch control of the motor vehicle, can also be described as protected and/or secure functions, which functions are supported within or by the user terminal device by means of a secure module, or are implemented therein. A secure module of this type can comprise both hardware components, for example, in the form of a secure processor and/or a protected memory, and software components, for example, one or more apps or programs, which hardware and software components cooperate.

To this end, the at least one user terminal device is typically associated with the at least one motor vehicle, such that one or more user terminal devices are known to the motor vehicle, are registered therein and/or are authorized for the execution or initiation of the above-mentioned functions, and of further functions, on the motor vehicle. To this end, the user terminal device(s) comprises (comprise) a digital access key which, for example, is saved and/or processed in the secure module, in particular in an exclusive manner.

The user who executes one or more user inputs on the user terminal device, in response to which one or more such functions are implemented, is, for example, the owner, keeper, holder, authorized user and/or a driver or passenger of the motor vehicle and of user terminal device(s) and, in particular, is routinely and/or permanently authenticated for the execution or initiation of these functions by means of the user terminal devices.

In the present case, according to the invention, an approach of at least one user terminal device to the motor vehicle is detected.

An approach signifies a proximity to and an incursion within a predefined clearance to the motor vehicle, for example, an approach to within 50 m, 25 m, 15 m, 10 m or 5 m of the motor vehicle. An approach comprises an incursion within a range of one or more wireless transceivers such as one or more Bluetooth transceivers which are arranged on the vehicle and/or are incorporated therein.

Determination of the approach of the at least one user terminal device to the motor vehicle can also be executed by means of triangulation and/or propagation delay measurements between one or more transceivers of the motor vehicle and one or more transceivers of the user terminal device.

One or more transceivers of the motor vehicle and one or more transceivers of the user terminal device communicate in a routine or periodic manner, and exchange data and/or information, in particular by means of one or more wireless communication protocols. In particular, the wireless communication protocol can be one or more of the following: Bluetooth, in particular Bluetooth low energy or LE, UWB, NFC, RFID and/or WLAN.

Moreover the motor vehicle and/or the user terminal device routinely or periodically ascertain whether, and to what extent the user terminal device and the motor vehicle assume a mutual proximity.

An approach of the user terminal device to the motor vehicle also triggers the method, or the method commences with this step.

In a further step, a first user input of a user is acquired on a user terminal device.

The user input is acquired in response to the capture of an approach of a user terminal device to the motor vehicle, or the user input is executed subsequently to the approach.

A user input comprises an interaction with the user terminal device, which interaction can comprise, for example, a speech input, a gestural input and/or a contact input, as further described hereinafter.

This user input is employed for initiating an execution of one or more safety-related functions, or this input is indicative of a user intention to initiate at least one safety-related function. A safety-related function of the motor vehicle is not commenced or executed in the event that the user approaches the motor vehicle, but does not execute any input.

A user input comprises a type and/or a scope of a desired or intended execution of a safety-related function. For example, the user input comprises an intent to open the driver door, to open the rear left-hand side window, to open all the side windows and/or to close the trunk lid, as further described hereinafter.

Acquisition of a user input and, optionally, the type and/or scope thereof, can then be communicated to the motor vehicle, in particular by means of a wireless communication protocol, as described above.

The user terminal device, the approach of which is acquired, can be distinguished from the user terminal device on which the first user input and/or the second user input is acquired. An approach of a first user terminal device which is assigned to the user, can be acquired, and a user input on a second user terminal device, which differs from the first user terminal device and which is assigned to the same user as the first user terminal device, can be acquired.

Both the first user terminal device, the approach of which is acquired, and the second user terminal device, on which the first user input is captured, are associated with the motor vehicle, are registered therein and/or are authorized for the execution or initiation of the above-mentioned safety-related functions, or of further additional functions, on the motor vehicle.

In a further step, in response to the previously acquired first user input, an execution of at least one safety-related function of the motor vehicle is initiated. In particular, a safety-related function of this type is executed and/or actuated.

Actuation can be executed by means of one or more actuation devices of the motor vehicle such as, for example, a motor, in particular a servomotor and/or an actuator, which devices can be controlled by a control device.

In a further step, a second user input of a user is acquired on a user terminal device.

Thus, further to the commencement of execution and, more particularly, prior to the completion of execution of the safety-related function, a further and second user input of a user can be received.

In particular, this can occur in the event that one or more users of the motor vehicle detect a hazard situation which, as a result of the execution of the safety-related function, is impending or has already occurred, such as, for example, a crushing or compression of one or more limbs of a person, in particular of a child, and/or of an object such as, for example, an item of luggage.

In particular, it is intended that this function should be enabled additionally to any exemplarily provided crush protection function, to avert any such crushing prior to the onset of attention on the part of one or more users.

The user who delivers the second user input can be the same user as the user who delivers the first user input. Alternatively or additionally, this can also be a different and second user.

The first user input can also be of the same type as the second user input. Alternatively or additionally, the first user input and the second user input can be mutually different, particularly with respect to the content and/or the type thereof, as further described hereinafter.

Likewise, the user terminal device on which the first user input is delivered or acquired can be the same user terminal device as the terminal device on which the second user input is delivered or acquired. Alternatively or additionally, two or more different user terminal devices can be employed, as likewise further described hereinafter.

In a further step, the previously initiated or commenced execution of the safety-related function of the vehicle is interrupted in response to the second user input.

In particular, the actuation process or an achievement of a second resting position at the time of acquisition of the second user input and/or of the interruption of actuation has not been completed, or has not yet been completed in a regulation manner, but has rather been interrupted, not further pursued and/or not completed as a result of, or in response to the second user input, such that the execution of the safety-related function, in particular exceptionally, is interrupted and/or suspended. This can also be achieved by means of one or more actuation devices and/or by means of a control device, as described above.

By means of the method according to the invention, an initiation of a safety-related function of a motor vehicle is enabled and, optionally, an interruption or suspension thereof, in particular prior to the completion of the safety-related function, for example in the event of an emergency to the effect that, as a result of the safety-related function, a crushing of a limb is impending or has already occurred. A particularly secure execution of a safety-related function is enabled accordingly.

According to a further development, the safety-related function comprises an actuation of a hatch of the motor vehicle.

Thus, according to this further development, a hatch of the motor vehicle is controlled, which hatch is firstly actuated in response to the first user input, and is halted in response to the second user input.

A hatch can comprise any opening of the motor vehicle which closes an element of the interior, and the actuation of which executes the at least partial release thereof.

For example, the hatch is a door such as, for example, a driver door, a passenger door, one or more rear doors and/or a tailgate or tail hatch.

By way of a further example, the hatch is a rear and/or front trunk lid.

By way of a further example, the hatch is a tank cover and/or a cover for a charging connection. By way of a further example, the hatch is a window such as, for example, a side window, in one or more of the above-mentioned doors, and/or a rear window, in particular in a rear trunk lid.

In particular, an actuation can comprise a movement of the at least one hatch, in particular an opening and/or closing, a complete opening and/or closing, and/or an opening to the extent of a predetermined maximum opening angle, such that a driver and/or passenger can board the motor vehicle.

Alternatively or additionally, actuation can also comprise an opening by only a fraction of the maximum opening angle, by a minimum angle, which angle is particularly configured such that hatch can be manually opened thereafter using a hand, in particular without actuating a handle and/or a lever.

Further alternatively or additionally, actuation can comprise a locking and/or unlocking and, in particular, exclusively a locking and/or unlocking, further to which the hatch can then be opened manually by actuating a handle or lever.

In particular, prior to actuation, the hatch was stationary and/or has not moved. In particular, by means of actuation, the hatch is moved from a first resting position such as, for example, a closed and/or locked position, for the achievement of a second resting position, for example, and open and/or unlocked position.

By means of this further development, a particularly secure control of a hatch which can result in the crushing and/or compression of persons, is enabled.

According to a further development, the first user input differs from the second user input.

According to this further development, the first user input differs from the second user input with respect to the type thereof, the input medium thereof, and/or the input technology thereof.

For example, the first user input is an input which does not require a manual actuation of the user terminal device on the part of the user, whereas the second user input is an input which requires a manual actuation of the user terminal device on the part of the user, or vice versa.

In particular, the second user input comprises no type features of the first user input and/or vice versa. Further specific exemplary embodiments for the distinction of the type of user input are explained hereinafter.

By means of this further development, an initiation and interruption of the execution of the safety-related function on two different devices are enabled. For example, it is thus possible for the execution of the safety-related function to be initiated on a first device, the operation or actuation of which is more convenient and which, for example, is located in a pocket of the user, and to be interrupted on a second device, the operation or actuation of which can be executed in a simpler, more rapid and/or more failsafe manner and which, for example, is within holding distance or contact distance of the user.

According to a further development, the first user input comprises a gestural input and/or a speech input.

The first user input is exclusively a gestural input, exclusively a speech input, or comprises both types of user input, i.e., a gestural input and a speech input.

In particular, the first user input comprises no manual actuation on the part of a user such as, for example, an actuation of a button, of a key and/or a tactile input on a touchscreen by means of the hand and/or a finger of the user.

A gestural input is an input of the user which is based upon a movement of one or more body parts, in particular of limbs, such as an arm and/or a hand of the user. This gestural input, for example, can be acquired and also evaluated by means of one or more acquisition devices such as, for example, an acceleration sensor and/or an imaging sensor of the user terminal device.

For example, the user terminal device is a smart watch and/or a wearable device, and the gestural input is a raising or movement of a hand or of an arm, on which the smart watch or wearable device is worn, to a predefined point, in a predefined trajectory and/or over a predefined height which is acquired by an acceleration sensor.

By way of a further example, the user terminal device comprises smart glasses, and the gestural input is movement of a hand or of an arm, within the field of vision of the smart glasses, and further particularly to a predefined point, in a predefined trajectory and/or over a predefined height which is acquired by an imaging sensor.

By way of a further example, the user terminal device is a smart phone, a phablet or a tablet, and the gestural input is a raising or movement of the user terminal device, to a predefined point, in a predefined trajectory and/or over a predefined height which is acquired by an acceleration sensor.

In particular, this gestural input can also be a gesture which is predefined or set by the user, which gesture is indicative of user intention to execute a safety-related function, in particular for the actuation of a hatch and, in particular, for an opening and/or closing of a hatch, and can, but does not necessarily comprise a request to this effect.

In particular, from the gestural input alone, in consideration of proximity, it can be inferred that a user intends to execute a safety-related function, in particular an opening and/or closing of the hatch of the motor vehicle, and this function thus executed.

A speech input is an input of the user which is based upon spoken language. This speech input, for example, can be acquired and also evaluated by means of one or more recording devices such as, for example, a microphone of the user terminal device.

In particular, the speech input comprises a predefined activation word such as “Hey Siri” or “OK Google” and, optionally, a speech command or speech instruction. This speech command can also, but does not necessarily comprise a user intention to execute a safety-related function, to actuate a hatch and, in particular, to execute the opening and/or closing thereof, or a request to this effect.

From the speech input alone and/or from the activation word, in consideration of proximity, it can be inferred that a user intends to execute a safety-related function, in particular an opening and/or closing of the hatch of the motor vehicle, and this function thus executed.

A speech input and a gestural input can also be combined. For example, by means of one of the two input types, in particular gestural input, the fundamental execution of a safety-related function can be acquired or expressed, such as, for example, and actuation of a hatch and, by means of another of the two input types, in particular speech input, the manner or scope of the safety-related function such as, for example, the actuation of the hatch or hatches can be acquired or expressed.

For example, a gestural input is acquired first, which is indicative of an intention to open a hatch, for example a raising of an arm, and a speech input is acquired, thereafter, which is indicative of the intention to open the tailgate and all the side windows, which user intention is then implemented in practice.

By means of this further development, a particularly convenient execution of a safety-related function and an opening and/or closing of one or more hatches is enabled. In particular, a manual interaction such as, for example, an actuation of a button on the user terminal device, can thus be omitted, and the execution of a safety-related function such as, for example, the actuation of the hatch or hatches, can thus be securely enabled or initiated by means of a simple gestural input and/or speech input.

This further development is particularly appropriate for smart watches, smart glasses and/or wearable devices by way of a user terminal device. In particular, this further development is appropriate for devices which have no touchscreen, or only a small touchscreen.

According to a further development, the second user input comprises a tactile input.

In particular, the second user input comprises a tactile input only and, further particularly, comprises no speech input and/or no gestural input. Alternatively, however, the tactile input can also be combined with a further input form, in particular with a speech input.

A tactile input is thus a user input which requires or involves a physical interaction such as, for example, a manual actuation of the user terminal device. This tactile input can be executed using a hand, an arm, or other parts of the body which are in contact with part of the user terminal device.

In particular, the second user input comprises a touching of a touchscreen of the user terminal device, for example of a visually represented content thereof, such as a button and/or a key.

In particular, the content which is actuated by touching, in order to interrupt the execution of the safety-related function, such as the actuation of the hatch, is greater than 25%, 50% or 75% of the touchscreen area, and can be highlighted, for example by means of color and/or text.

Alternatively or additionally, the second user input also comprises an actuation of one or more physically configured buttons or keys. A dedicated button can be provided which receives or acquires this second user input, in particular exclusively, at least during the execution of the safety-related function, such as the actuation of the hatch, in order to execute the suspension or interruption thereof.

Alternatively or additionally, one or more arbitrary buttons, in particular one arbitrary button of all the buttons present on the user terminal device can be actuated, at least during the execution of the safety-related function, in order to interrupt the execution of the safety-related function.

To this end, additionally, an above-mentioned content can also be represented on the touchscreen, which content, additionally to one or more arbitrary buttons and/or to all the buttons, can also be employed for interrupting the execution of the safety-related function.

By means of this further development, a particularly secure interruption of actuation is enabled. A potentially fault-susceptible speech and/or gestural input can thus be omitted and, conversely, by means of a manual actuation, an interruption of movement is securely enabled.

This further development is particularly appropriate for smart watches, smartphones, phablets and/or tablets by way of a user terminal device. This further development is appropriate for devices having at least one touchscreen, in particular a large touchscreen.

According to a further development, the user terminal device on which the first user input is acquired is a first user terminal device, and the user terminal device on which the second user input is acquired in a second user terminal device which differs from the first user terminal device.

The first user input is thus acquired on a device which is differently configured from the device on which the second user input is acquired.

For example, two different devices are involved which can be sourced from the same manufacturer and/or can be of the same type, but which comprise at least two different, i.e. mutually separately configured user devices.

In particular, the first user terminal device can be assigned to a first user, or associated with an account of a first user, and the second user terminal device can be assigned to a second user, or associated with an account of a second user.

Alternatively or additionally, the first user terminal device and the second user terminal device can be assigned to one and the same single user, or associated with an account of one and the same single user.

In particular, the first user terminal device can be endowed with rights for the execution of a safety-related function such as, for example, an actuation of a hatch of the motor vehicle, whereas the second user terminal device is not thus endowed.

In particular, it is possible that the second user terminal device is not associated with the motor vehicle or registered therein and/or, in particular, is not authorized for the execution or initiation of the above-mentioned safety-related functions, such as the actuation of a hatch, and further additional functions.

In particular, however, it is also possible for two different types of devices to be involved wherein, for example, a first user terminal device is a smart watch, smart glasses and/or a wearable device, and the second user terminal device is a smartphone, a phablet and/or a tablet.

In particular, the first user terminal device comprises no touchscreen, and the second user terminal device comprises a touchscreen.

Likewise, in particular, the first user terminal device is configured for the acquisition of a gestural input and/or a speech input, and the second user terminal device is not configured for the acquisition of a gestural input and/or a speech input.

It is also exemplarily possible for devices of the same variety or type to be employed, but sourced from two different manufacturers or having two different operating systems.

Representations provided herein with respect to the first and second user terminal device also apply correspondingly in the invent of the involvement of a further user terminal device, described herein as a third user terminal device, the proximity of which is acquired and which can be differently configured from the user terminal device which is described herein as the first user terminal device. In particular, the association with ordinal numbers is arbitrary, and is provided by way of a notional distinction only.

By means of this further development, the employment of various user terminal devices is enabled, for interrupting actuation, particularly including such devices as are not configured and/or authorized for actuation. A passer-by or third party can also initiate an interruption of actuation, in the event of the detection thereby of a hazard, conversely to the user of the first user terminal device.

According to a further development, the acquisition of an approach comprises an acquisition of the first user terminal device and of the second user terminal device.

Thus, in an initial step of the method, not only the first user terminal device, but also the second user terminal device, or the approach thereof, are acquired.

Alternatively or additionally, the second user terminal device is acquired at the time at which the first user terminal device has been acquired and/or at which the execution of a safety-related function has been initiated, or is acquired or triggered thereafter as a result thereof.

In particular, both at or in conjunction with the time of acquisition of the first user terminal device or of an authorized user terminal device, and at or in conjunction with the time of acquisition of the first user input and/or of the execution of the safety-related function, a second and, in particular, further, in particular all user terminal devices in proximity to or within the range of the motor vehicle are acquired.

By means of this further development, it is enabled that the second user terminal device, and an interruption of execution of the safety-related function which is possible by means thereof, for example, the actuation process of the hatch, is acquired in a particularly prompt manner, and is thus enabled.

According to a further development, the method further comprises a step for the generation of an input request in response to the execution of the safety-related function, wherein the acquisition of the second user input is executed in response to the generation of the input request.

The input request can be generated on the first user terminal device and/or on the second user terminal device and/or on further user terminal devices. As described above, a visually represented content can be displayed or generated on a touchscreen, which content also comprises an input request for the attention of a user or users of the user terminal device on which the second user input has been acquired or received.

A visual button or key can be provided with a textual request to the effect that an interruption of the execution of the safety-related function of the motor vehicle is possible by means of a second user input.

Alternatively or additionally, the input request can also be executed by a different means, for example by means of an acoustic and/or speech output which alerts a user of the user terminal device on which the second user input is acquired or received to the effect that the second user input is possible.

In particular, the input request can also deliver further information, for example the type, model, manufacturer and/or color of the motor vehicle on which the execution of the safety-related function is initiated, and the direction and/or distance to the motor vehicle.

The input request can be generated exclusively for the duration of actuation and/or pending the interruption of the execution of the safety-related function.

By means of this further development, the notification of one or more users of a potential interaction, and thus of a facility for interruption, is thus enabled in a particularly active manner.

According to a further development, the method further comprises a step for the acquisition of multiple user terminal devices in the vicinity of the motor vehicle, wherein the generation of the input request is executed on multiple user terminal devices.

As described above, two, three or more user terminal devices in the vicinity of the motor vehicle, and particularly within the range thereof, can be acquired. These can be both multiple user terminal devices which are assigned to the user or which are associated with the motor vehicle, are registered therein and/or, in particular, are authorized for the execution or initiation of the above-mentioned safety-related functions on the motor vehicle, such as the actuation of a hatch, and of further functions, in particular exclusively to this effect, and one or more user terminal devices which are not assigned to the user and/or are not associated with the motor vehicle, registered therein and/or, in particular, authorized for the execution or initiation of the above-mentioned safety-related functions, such as the actuation of a hatch, and of further functions.

On the multiple user terminal devices thus acquired, the input request can then be generated, as described above.

By means of this further development, the involvement of particularly numerous user terminal devices, and thus users, is enabled in the potential interruption process.

According to a further development, the method further comprises a step for the acquisition of all the user terminal devices in the vicinity of the motor vehicle, wherein the generation of the input request is executed on all the user terminal devices thus acquired.

All user terminal devices in the vicinity of the motor vehicle, in particular located within the range thereof, are acquired accordingly. These can be both multiple user terminal devices which are assigned to the user or which are associated with the motor vehicle, are registered therein and/or, in particular, are authorized for the execution or initiation of the above-mentioned safety-related functions on the motor vehicle, such as the actuation of a hatch, and of further functions, in particular exclusively to this effect, and one or more user terminal devices which are not assigned to the user and/or are not associated with the motor vehicle, registered therein and/or, in particular, authorized for the execution or initiation of the above-mentioned safety-related functions, such as the actuation of a hatch, and of further functions.

On all the user terminal devices thus acquired, the input request can then be generated, as described above.

By means of this further development, the involvement of all users within the vicinity of the motor vehicle in the interruption process is enabled.

According to a further aspect, a device is disclosed having means for the execution, or at least for the initiation of an embodiment of the above-mentioned method.

In particular, the device comprises one or more processors for the execution of the above-mentioned method. In particular, the device also comprises a memory on which code is saved, in particular a non-volatile memory, which code, upon the execution thereof by a processor, initiates the execution by the latter of the above-mentioned method.

In particular, the device can comprise the first user terminal device, the second user terminal device, further user terminal devices and/or the motor vehicle, thus forming a system, and/or can cooperate therewith for the execution of the above-mentioned method.

Further features of the invention proceed from the claims, the figures and the description of the figures. Features and combinations of features specified in the preceding description, and features and combinations of features specified hereinafter in the description of the figures, and/or represented in the figures alone, are not only applicable in the respectively indicated combination, but also in other combinations or in isolation.

Other objects, advantages and novel features of the present invention will become apparent from the following detailed description of one or more preferred embodiments when considered in conjunction with the accompanying drawings.

The invention is described in greater detail hereinafter with respect to a preferred exemplary embodiment, and with reference to the drawings. In the FIGURE:

### BRIEF DESCRIPTION OF THE DRAWING

FIG. 1 shows a schematic side view of one embodiment of a method and a device for controlling a safety-related function of a motor vehicle.

### DETAILED DESCRIPTION OF THE DRAWING

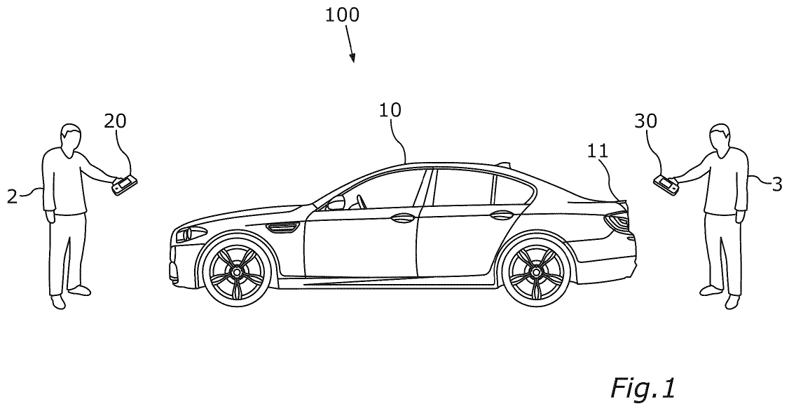

FIG. 1 shows a schematic side view of one embodiment of a method and a device 100 for controlling a safety-related function such as the actuation of a hatch 11 of a motor vehicle 10.

The device 100 is configured to cooperate with the motor vehicle 10, a first user terminal device 20 of a first user 2 and a second user terminal device 30 of a second user 3, and to execute or initiate the method in the following steps.

The first user terminal device 20 is exemplarily illustrated as a smartphone, and is assigned to a first user 2 who is also the user or driver of the motor vehicle 10. The first user terminal device is authorized to execute or initiate a safety-related function with respect to the motor vehicle 10, in particular a control of the hatch 11 which, in the present case, is exemplarily represented as a tailgate of the motor vehicle 10.

The second user terminal device 30 is distinct from the first user terminal device, is also exemplarily illustrated as a smartphone, and is assigned to a second user 3. The second user terminal device 30, conversely to the first user terminal device 20, is not authorized to execute or initiate a safety-related function with respect to the motor vehicle 10, in particular a control of the hatch 11.

The device 100 is configured to acquire an approach of the first user terminal device 20 and of the second user terminal device 30 to the motor vehicle 10.

The device 100 is also configured to acquire further, in particular all, user terminal devices in the vicinity of the motor vehicle 10, which devices are not represented here.

The device 100 is also configured to acquire a first user input of the first user 2 on the first user terminal device 20.

The first user input comprises a gestural input of the first user 2.

The device 100 is also configured to execute the safety-related function which, in the present case, is exemplarily described as an actuation of the hatch 11 of the motor vehicle 10 in response to the first user input, in the present case to execute the opening thereof from the closed state represented.

The device 100 is also configured to generate an input request in response to the execution of the safety-related function on the first user terminal device 20 and the second user terminal device 30, and on further, in particular on all the user terminal devices thus acquired.

The device 100 is also configured to acquire a second user input of the second user 3 on the second user terminal device 30, which differs from the first user terminal device 20, in response to the input request generated.

The second user input comprises a tactile input of the second user 3.

The device 100 is also configured to interrupt the previously commenced execution of the safety-related function such as, in the present case, an actuation of the hatch 11 of the motor vehicle 10, in response to the second user input.

In the exemplary scenario represented herein, the first user 2, by means of their first user input, has opened the tailgate, but in the absence of any sight thereof. The second user 3, conversely, is located in proximity to the tailgate, and perceives an impeding collision of the hatch 11 with another unrepresented object. On the grounds of the generation of the input request, and by a recognition of the situation, the second user 3 is enabled to interrupt the opening of the tailgate and thus avert the impending collision.

For the hands-free user control (e.g., by voice or gesture) of a vehicle function, according to a preferred embodiment, all digital keys within the range of the vehicle can display a key, by means of which the operation of the vehicle function can be interrupted. The display of the stop key can optionally be requested by means of the vehicle, using BLE (Bluetooth Low Energy) or, by means of digital keys which are associated with the same account or with the same person (e.g., from a smartphone or watch), the display of the stop key can be controlled independently. For example, the door can thus be closed by means of voice-activated user control. The user carries, e.g., a smart watch and a smartphone. Both devices have a digital key, and are located in proximity to the vehicle. The speech command for closing the door is detected, for example, by the smart watch, and is transmitted to the vehicle. For such time as the door is in motion, the smart watch displays a stop key by means of which the user can interrupt the closing procedure at any time. The vehicle moreover requests, by means of a BLE message, the display of a stop key on the smartphone.

Overall, a continuous operation of vehicle functions can be implemented with hands-free actuation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

2 First user
3 Second user
10 Motor vehicle
11 Hatch
20 First user terminal device
30 Second user terminal device
100 Device

What is claimed is:

1. A method for controlling a safety-related function of a motor vehicle, the method comprising:
acquiring an approach of a user terminal device to a motor vehicle;
acquiring a first user input of a user on a user terminal device;
executing a safety-related function of the motor vehicle in response to the first user input;
acquiring a second user input of the user on the user terminal device; and
interrupting the execution of the safety-related function of the motor vehicle in response to the second user input.

2. The method according to claim 1, wherein the safety-related function comprises an actuation of a hatch of the motor vehicle.

3. The method according to claim 1, wherein the first user input differs from the second user input.

4. The method according to claim 2, wherein the first user input differs from the second user input.

5. The method according to claim 1, wherein the first user input comprises at least one of a gestural input or a speech input.

6. The method according to claim 2, wherein the first user input comprises at least one of a gestural input or a speech input.

7. The method according to claim 3, wherein the first user input comprises at least one of a gestural input or a speech input.

8. The method according to claim 1, wherein the second user input comprises a tactile input.

9. The method according to claim 2, wherein the second user input comprises a tactile input.

10. The method according to claim 3, wherein the second user input comprises a tactile input.

11. The method according to claim 1, wherein the user terminal device, on which the first user input is acquired is a first user terminal device, and the user terminal device, on which the second user input is acquired, is a second user terminal device which differs from the first user terminal device.

12. The method according to claim 2, wherein the user terminal device, on which the first user input is acquired is a first user terminal device, and the user terminal device, on which the second user input is acquired, is a second user terminal device which differs from the first user terminal device.

13. The method according to claim 3, wherein the user terminal device, on which the first user input is acquired is a first user terminal device, and the user terminal device, on which the second user input is acquired, is a second user terminal device which differs from the first user terminal device.

14. The method according to claim 11, wherein the acquisition of an approach comprises an acquisition of the first user terminal device and of the second user terminal device.

15. The method according to claim 1, further comprising:
generating an input request in response to the execution of the safety-related function;
wherein the acquisition of the second user input is executed in response to the generation of the input request.

16. The method according to claim 15, further comprising:
acquiring multiple user terminal devices in a vicinity of the motor vehicle;
wherein the generation of the input request is executed on the multiple user terminal devices.

17. The method according to claim 15, further comprising:
acquiring all user terminal devices in a vicinity of the motor vehicle;
wherein the generation of the input request is executed on all the user terminal devices acquired.

18. The method according to claim 16, further comprising:
acquiring all user terminal devices in a vicinity of the motor vehicle;
wherein the generation of the input request is executed on all the user terminal devices acquired.

19. A device for controlling a safety-related function of a motor vehicle, wherein the device executes a method according to claim 1.
